(19) United States
(12) Patent Application Publication
(10) Pub. No.: US 2008/0229359 A1
(43) Pub. Date: Sep. 18, 2008

(54) SMART INTERACTIVE PROGRAM GUIDE

(76) Inventor: W. Andrew Robinson, Suwanee, GA (US)

Correspondence Address: Wm. Brook Lafferty;Scientific-Atlanta, Inc., Intellectual Property Dept. MS 4.3.518, 5030 Sugarloaf Parkway, Lawrenceville, GA, 30044, US

(21) Appl. No.: 11/685,826

(22) Filed: Mar. 14, 2007

(51) Int. Cl. H04N 5/445

(52) U.S. Cl. 725/46

(57) ABSTRACT

Systems, methods, and applications for controlling an interactive program guide (IPG) to be displayed on a display screen are disclosed herein. According to one embodiment, among others, an application is stored in memory and is configured to control an IPG. The application comprises logic configured to maintain a data structure. The data structure includes a first category corresponding to a plurality of media services and a second category corresponding to a first value representing the number of times that a tuner system tunes to each one of the media services. The application also comprises logic configured to detect when the tuner system tunes to a particular media service channel. In addition, the application comprises logic configured to increment the first value related to the particular media service channel in response to detecting the tuner system tuning to the particular media service channel.

### TECHNICAL FIELD

The present disclosure generally relates to television program guides. More particularly, the disclosure relates to systems and methods for presenting a list of channels and/or media services based on a user's viewing behavior.

### BACKGROUND

Cable television providers offer a range of television service plans or packages to allow a subscriber to access a number of television channels and/or other media services. With the large number of channels available to a viewer under most plans, it can be difficult at times for a viewer to sort through the channels that may be of the most interest to the viewer. Also, remembering the relationship between television services, e.g. ESPN, CNN, etc., and their corresponding channel numbers can at times be difficult. Thus, a need exists in the field of television systems to address the viewer's interests to provide a simplified and customized program guide to enhance the television viewing experience.

### BRIEF DESCRIPTION OF THE DRAWINGS

Many aspects of the embodiments disclosed herein can be better understood with reference to the following drawings. The components in the drawings are not necessarily to scale, emphasis instead being placed upon clearly illustrating the principles of the present disclosure. Like reference numerals designate corresponding parts throughout the several views.

FIG. 1 is a diagram of an embodiment of a television service system.

FIG. 2 is a block diagram of an embodiment of the memory device shown in FIG. 1.

FIG. 3 is a front view of an embodiment of the remote control device shown in FIG. 1.

FIG. 4 is a screen view illustrating an embodiment of an exemplary program guide having a Smart IPG section according to the teachings of the present disclosure.

FIGS. 5A-5E are screen views illustrating embodiments of an exemplary options menu for customizing the program guide of FIG. 4.

FIGS. 6A and 6B are tables illustrating exemplary data related to a collection of information regarding a viewer's channel tuning behavior.

FIG. 7 is a flow chart of an embodiment of a routine for collecting information concerning tuned channels.

FIG. 8 is a flow chart of an embodiment of a routine for ranking channels or services based on the information collected with respect to FIG. 7.

### DETAILED DESCRIPTION

The present disclosure describes systems and methods for providing an interactive program guide (IPG) that automatically determines the channels that are tuned-to most frequently. The channels may represent television channels, music channels, game channels, digital video recording (DVR) channels, etc. By counting the number of times that viewers within a residence tune to different channels, a table can be maintained that includes the tuned-to count for each channel. From the table entries, a list can be produced of the television channels with the highest tuned-to counts. In this respect, when the IPG is first presented on the television screen, the IPG can automatically display the list of channels in an order based on the viewing behavior of the viewers.

Specifically, a “Smart IPG” program can be used, as described herein, to manage the counts and channel order. This program can run automatically within a viewer's set-top box or other suitable control system to provide a program guide, such as a television program guide, which is generally customized according to the viewers' tendencies. In particular, the tendency of the viewer to tune to specific channels determines the channel ranking in the Smart IPG.

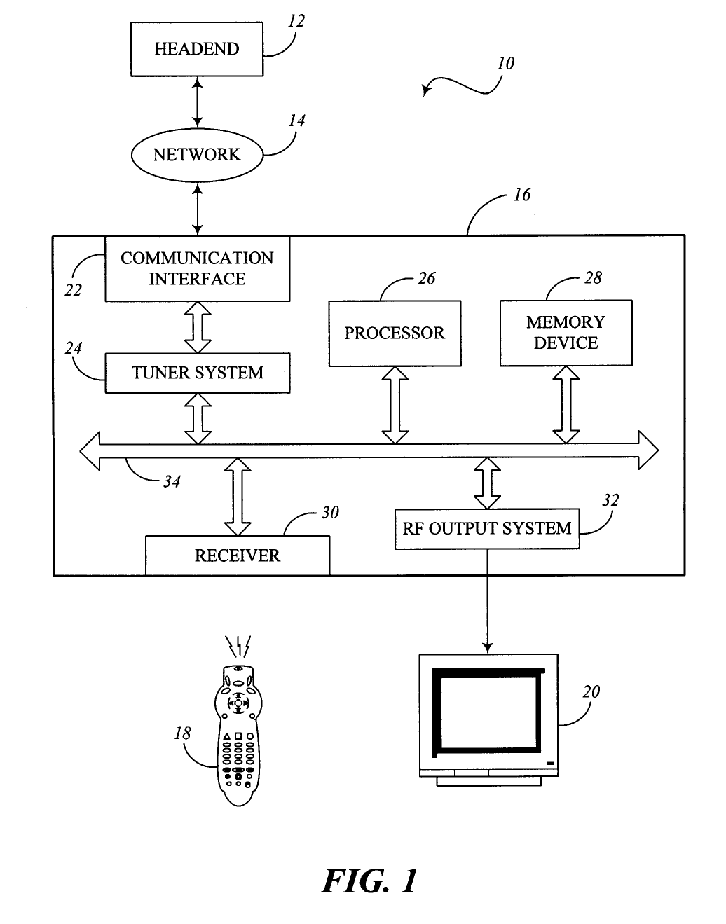

FIG. 1 is a block diagram of an embodiment of a video communication system 10 in which a Smart IPG program can be incorporated. The video communication system 10 includes a headend 12, a communication network 14, a set-top box 16, a remote control device 18, and a television 20. In this embodiment, the set-top box 16, which outputs RF signals to the television 20, includes a communication interface 22, tuner system 24, a processor 26, a memory device 28, a receiver 30, and an RF output system 32, each interconnected via a bus interface 34.

In some embodiments, the set-top box 16 may include other arrangements and/or components or may be configured as any other suitable processor-controlled device for providing RF signals to a display screen. With the advent of such technologies as CableCARD™, the features of the set-top box 16 may be included in a television set. In this respect, the set-top box 16 may instead be a processing device incorporated within the television 20, which may be capable of downloading an IPG (e.g., IPG data) from the headend 12. In other embodiments, the set-top box 16 may be a computer, video iPod™, etc. In addition, the television 20 may include a television set, computer monitor, handheld display device, or other suitable image-displaying device.

The headend 12 communicates with the set-top box 16 via the communication network 14, which may include a combination of hubs, nodes, etc. Some of the functionality performed by applications executed in the set-top box 16 may instead be performed at the headend 12 (or other components in the network) and vice versa. The communication interface 22 receives signals (video, audio and/or other data) from the headend 12 through the network 14 and can provide upstream information back to the headend 12 through the network 14. The processor 26 controls operations and functions of the set-top box 16. The tuner system 24 tunes to a particular television channel and the RF output system 32 drives the television 20 to display the channel to which the tuner system 24 is tuned. The tuner system 24 may include, in some implementations, an out-of-band tuner for bi-directional quadrature phase shift keying (QPSK) data communication and a quadrature amplitude modulation (QAM) tuner for receiving television signals.

Additionally, the receiver 30 is capable of receiving externally generated information, such as inputs or commands from devices controlled by a user or viewer. For example, the information may be received from the remote control device 18 or other suitable user input device. In other embodiments, the user inputs may be provided by a computer or transmitter, for example, having buttons or keys located either on the exterior of the set-top box 16 or on a keyboard that includes user-actuated buttons.

The set-top box 16 may also include one or more wireless or wired interfaces or ports adapted to receive and/or transmit data to other devices. For instance, the set-top box 16 may include a Universal Serial Bus (USB), Ethernet (for connection to a computer), IEEE-1394 (for connection to media devices in an entertainment center), serial, and/or parallel ports.

According to some implementations, the memory device 28 may include flash memory and/or dynamic random access memory (DRAM), for example, for storing various applications, modules, and data for execution and use by the processor 26. Basic functionality of the set-top box 16 is provided by an operating system that is primarily stored in flash memory of the memory device 28. Software applications may be downloaded from the headend 12 into the memory device 28. The processor 26 may run any application or program to perform any number or type of video-related functions.

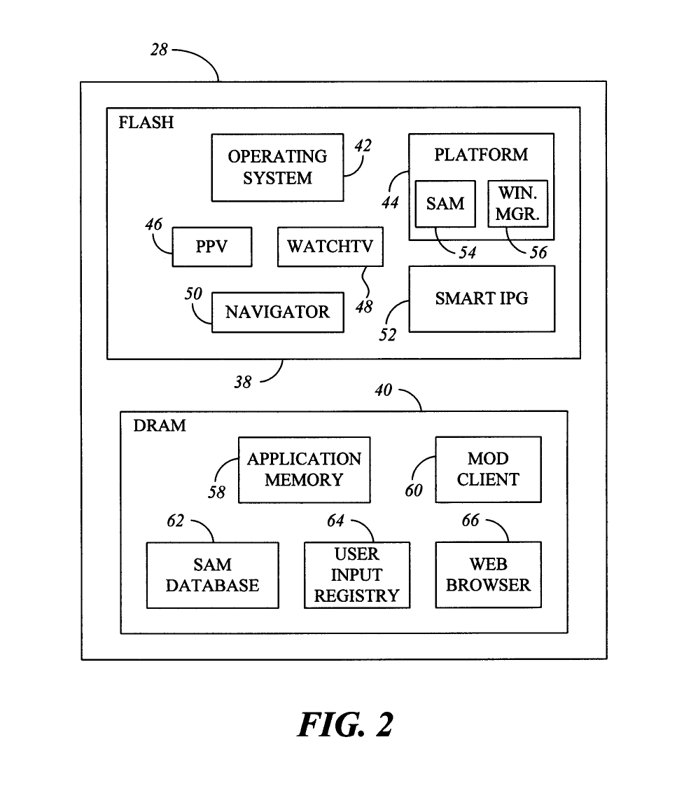

FIG. 2 is a block diagram of one embodiment, among others, of the memory device 28 shown in FIG. 1. In this embodiment, the memory device 28 includes flash memory 38 and DRAM 40. The flash memory 38 includes an operating system 42, platform library 44, pay-per-view applications 46, WATCHTV applications 48, a navigator application 50, and a Smart interactive program guide application (Smart IPG) 52. The platform library 44 includes a service application manager (SAM) 54 and a window manager 56. The DRAM 40 includes application memory 58, MOD client applications 60, a SAM database 62, user-input registry 64, and a web browser 66. Except for the Smart IPG 52, the functions of many of the components within the memory device 28 may be known and are not further described herein. Also, it should be understood that the memory device 28 may include more or fewer components than shown in FIG. 2 without departing from the spirit and scope of the present disclosure.

In addition to the SAM 54 and window manager 56, the platform library 44 may also include a collection of other utilities useful to applications. For example, the platform library may also include a timer manager, a compression manager, a configuration manager, an HTML parser, a database manager, a widget toolkit, a string manager, and other utilities (not shown). These utilities can be accessed by applications, such as the Smart IPG 52, via application programming interfaces (APIs) as necessary so that each application does not have to contain these utilities.

The window manager 56 provides a mechanism for implementing the sharing of the screen regions and user input. The window manager 56 is responsible for, as directed by one or more applications, implementing the creation, display, and de-allocation of the screen resources. It allows multiple applications to share the screen by assigning ownership of screen regions, or windows. The window manager 56 also maintains, among other things, the user input registry 64 in DRAM 40.

The navigator application 50 residing in flash memory 38 provides a navigation framework for services provided by the set-top box 16. The navigator 50 registers for and, in some cases, reserves certain user inputs related to navigational keys such as channel increment/decrement, last channel, favorite channel, etc. Client applications may be resident in flash memory 38 or downloaded into DRAM 40. The navigator 50 also provides users with television related menu options that correspond to the set-top box 16. For example, the navigator 50 may provide an interactive program guide (IPG) or even a program guide having a Smart IPG feature, as is described in the present disclosure. The navigator 50 may also block a particular channel or group of channels from being displayed in a channel menu, and may display a video-on-demand purchase list.

The SAM 54 is a client component of a client-server pair of components, with the server component being located at the headend 12. The SAM database 62 in DRAM 40 includes a data structure of services and a data structure of channels that are created and updated by the headend 12. Many services can be defined using the same application component with different parameters. Examples, among others, of services include presenting television programs (available through the WatchTV application 48), pay-per-view events (available through the PPV application 46), media-on-demand, an interactive program guide (IPG), and a Smart IPG. In general, the identification of a service includes the identification of an executable application that provides the service along with a set of application-dependent parameters that indicate to the application the service to be provided. The SAM client 54 also interfaces with a resource manager (not shown) to control resources of the set-top box 16.

Furthermore, with respect to the embodiment of FIG. 2, the flash memory 38 includes the Smart IPG 52, which operates in accordance with the teachings described herein. The Smart IPG 52, for example, may be downloaded from the headend 12 and updated if necessary. The Smart IPG 52 is designed to record the number of times that the users tune to each available television channel. By keeping track of the tuned-to counts for each channel, the Smart IPG 52 can create a list of the channels in an order based on the tuned-to counts. Thus, the channel that is tuned to the most number of times is listed first and the channel with the fewest number of tuned-to counts is last on the list.

The Smart IPG 52 of the present disclosure can be implemented in hardware, software, firmware, or a combination thereof. In some embodiments, the Smart IPG 52 can be implemented in software or firmware that is stored in a memory, such as memory device 28, and that is executed by a suitable instruction execution system, such as processor 26. If implemented in hardware, as in an alternative embodiment, the Smart IPG 52 can be implemented with any suitable combination of discrete logic circuitry, an application specific integrated circuit (ASIC), a programmable gate array (PGA), a field programmable gate array (FPGA), etc.

The Smart IPG 52 can comprise an ordered listing of executable instructions for implementing logical functions and can be embodied in any computer-readable medium for use by an instruction execution system, apparatus, or device, such as a computer-based system, processor-controlled system, or other system. In the context of this document, a “computer-readable medium” can be any medium that can contain, store, communicate, propagate, or transport the program for use by the instruction execution system, apparatus, or device. The computer-readable medium can be, for example, an electronic, magnetic, optical, electromagnetic, infrared, or semiconductor system, apparatus, device, or propagation medium. In addition, the scope of the embodiments disclosed herein include the described functionality embodied in logic in hardware or software-configured mediums.

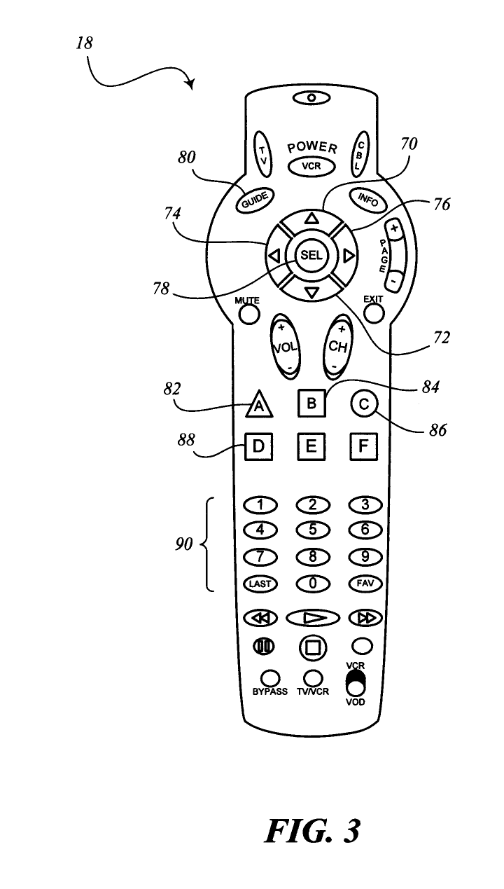

FIG. 3 is a view of an exemplary embodiment of the remote control device 18 shown in FIG. 1. It should be understood that this embodiment is merely one example of a remote control device that can be used with this system. However, the remote control device instead can include a different arrangement of buttons and controls, or a different device in some embodiments. Also, the remote control device 18, in conjunction with the set-top box 16, can include any suitable process for a user to input information. In this embodiment, the remote control device 18 includes, for example, arrow buttons, such as an up arrow button 70, a down arrow button 72, a left arrow button 74, and a right arrow button 76, which may be used to scroll through options and/or to highlight an option. The remote control device 18 also includes a select button 78 that may be used to select a currently highlighted option that is provided to the user.

The remote control device 18 also includes a guide button 80 that may be used to replace the regular television screen view with an IPG. In some embodiments, the IPG may be a program guide that includes a Smart IPG feature, as described herein. In other embodiments, the remote control device 18 may include the guide button 80 and an additional “Smart Guide” button (not shown) to allow the viewer to select, using the remote control device 18, either the regular program guide or a program guide with the Smart IPG feature. The remote control device 18 in this implementation further includes an “A” button 82, “B” button 84, “C” button 86, “D” button 88, etc. These lettered buttons are described in more detail below. Furthermore, the remote control device 18 may include number buttons 90, which are also described below.

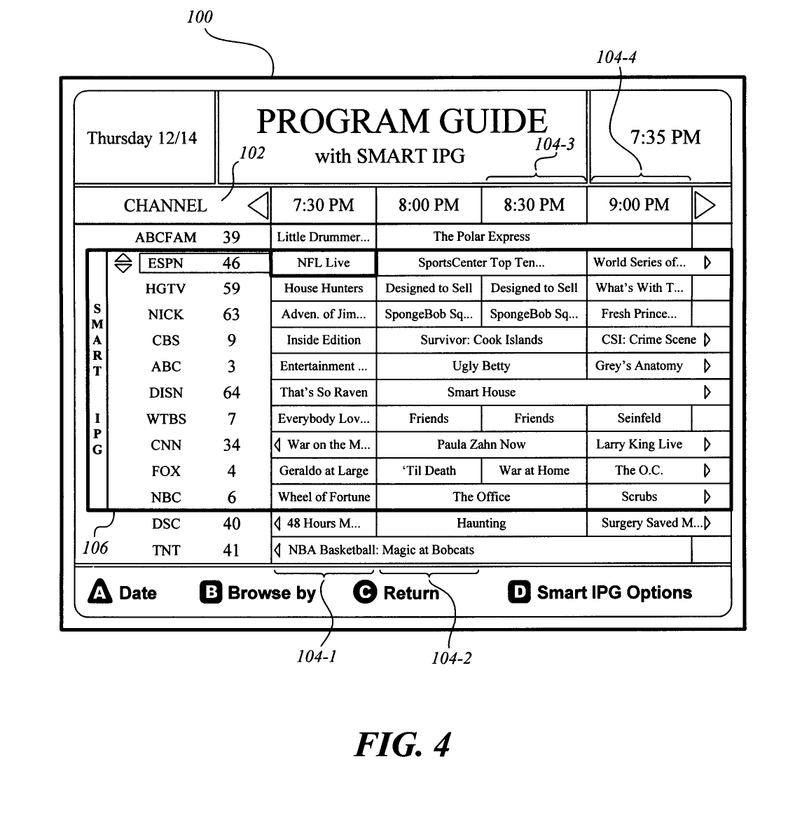

FIG. 4 is a diagram illustrating an exemplary embodiment of a program guide 100 having a Smart IPG feature. In this embodiment, the program guide 100 includes a channel column 102 and a number of program title columns 104. The channel column 102 includes a number of television services, e.g. ABCFAM, ESPN, HGTV, etc., and channel numbers, e.g. 39, 46, 59, etc., respectively corresponding to the television services. The channel listing may also list games, programs recorded by a DVR device, music channels, or other media services. In this respect, the listing in the channel column 102 may include any selectable channels or services from a channel map or media service listing.

Also, in this embodiment, four program title columns 104-1, 104-2, 104-3, and 104-4 are shown. It should be noted that the program guide 100 may include fewer or more program title columns 104 according to the particular design or as configured by a user. At the heading of each program title column 104, a time of day indication is included to show when the particular program titles, for example, are available via the particular channels. Typically, the times are shown in 30-minute increments, but may be configured in alternative time segments. Some titles may span across more than one time segment, representing a program that is longer than 30 minutes in length.

The program guide 100 includes a Smart IPG section 106, which may be presented in a variety of ways. In this embodiment, the Smart IPG section 106 is presented among a regular channel listing. In this embodiment, the Smart IPG section 106 is inserted between two channels having consecutive channel numbers 39 and 40, wherein channel 39 is the channel previously tuned-to immediately before initiation of the program guide 100. In other embodiments, the other channels outside the Smart IPG section 106 may initially be omitted. Yet, in some embodiments, the number of other channels outside the Smart IPG section 106 may be greater than or less than the number, i.e. three, shown in FIG. 4.

In many traditional program guides, the channels are listed in numerical order and the latest channel viewed is highlighted in the middle of the list. The channels having a lower channel number are typically positioned above the highlighted channel and the channels having a higher channel number are typically positioned below the highlighted channel. In contrast to the traditional program guide, however, the program guide 100 with Smart IPG includes the Smart IPG section 106 having the most frequently tuned-to channels in the middle of a regular list of channels, or, in some embodiments, may completely replace the regular list.

In this example, when other channels outside the Smart IPG section 106 are displayed in the program guide 100, the latest channel viewed may be positioned immediately above or immediately below the Smart IPG section 106. In some embodiments, the latest channel viewed may be listed twice, once above and once below the Smart IPG section 106, or not at all.

The Smart IPG section 106 includes a number of television services and corresponding channel numbers, similar to the orientation by which channels are displayed in a conventional program guide. However, instead of listing the channels in numerical order, the program guide 100 initially lists the channels within the Smart IPG section 106 according to the number of times that the viewers tune to that particular channels, which is likely not in numerical order. In the example of FIG. 4, the Smart IPG 52 displays ESPN as the most frequently tuned-to channel.

Furthermore, the Smart IPG section 106 of the program guide 100 may be configured to include any number of channels. For example, the Smart IPG section 106, as shown in FIG. 4, includes ten channels. However, one factor that may be considered in determining the number of channels is the amount of available space in the Smart IPG section 106. If more or less space is available for the Smart IPG section 106, the number of channels displayed may be changed accordingly. Also, the user may be able to select an option to change the number of channels, within certain guidelines, to be displayed within the Smart IPG section 106. In some embodiments, the selected number of channels included in the list of the Smart IPG section 106 may be greater than the available space reserved on the whole program guide for the channels. In this case, some channels in the Smart IPG may be reached by scrolling up or down, such as by a user pressing the up arrow 70 or down arrow 72 on the remote control device 18.

In addition, the Smart IPG section 106 may be displayed in the program guide 100 when the viewer initially requests the guide view. The Smart IPG 52 may remove the Smart IPG section 106 from between the regular numerically listed channels when the viewer scrolls to such an extent in one direction that the channels in the Smart IPG list are no longer visible. If the user scrolls downward or upward until the Smart IPG section 106 has scrolled off the screen, subsequent scrolling may show the standard IPG with the channels listed numerically in the order of the channel numbers (or other sort criteria as configured in the viewer preferences). However, after a viewer returns to regular media programming and initiates the program guide 100 at a later time, the program guide 100 is configured to show the Smart IPG section 106 again.

During the times when regular programming is displayed, the Smart IPG 52 (FIG. 2), operating in the background, counts the number of times that the viewer tunes to each channel. To be considered as a legitimate count, the Smart IPG 52 may require that a particular channel be tuned in for a particular time period. Otherwise, if a viewer quickly “surfs” through the channels, the counts of many channels may rise even though the viewer may not dwell on or have interest in dwelling on these channels. In this respect, the Smart IPG 52 may use a predetermined threshold time period to determine if a viewer has actually stopped on the channel for long enough to be considered a count. As an example, the predetermined threshold may be about one minute, or alternatively may be any suitable time period or may be configurable by a user.

Typically, the Smart IPG 52 may record every count representing the number of times each channel has been tuned to. However, because viewer patterns may change over time, the Smart IPG 52 may only record the counts over a certain preceding time interval. For example, the Smart IPG 52 may keep track of the tuned-to counts over a previous year. In some embodiments, other suitable time intervals may be used. In some embodiments, the Smart IPG 52 may count from the time of inception, e.g. from set-top installation, without purging older counts. In still other embodiments, the viewer may be able to use an option to purge the counts at any time. For example, this may be useful if the set-top box 16 is given to a new viewer or group of viewers, or if the viewers change service plans.

The Smart IPG 52 may also record tuned-to counts based on actual television or media services, such as ESPN, NBC, CNN, etc. In this respect, the Smart IPG 52 does not record the channel numbers per se since a cable operator may change the channel lineup or channel map at any time. In the case when the channel numbers are changed, the Smart IPG 52 automatically applies the new channel numbers to the corresponding television service. It should therefore not be necessary for a viewer to restart or purge the counts when channel designations are changed by the cable operator.

For a set-top box that is newly leased to a subscriber or newly purged of its Smart IPG list for various reasons, the Smart IPG 52 may still have a default list of particular channels. The default list may be a list of commonly viewed or popular channels that other users may ordinarily watch. Alternatively, the default list may be the first number of channels of the channel map or other types of factory default lists.

As a viewer is viewing a media program, the viewer may wish to call up the program guide to find out about other programs that may be available during certain times of the day. The Smart IPG 52 enables the viewer to call up the program guide 100 using any number of techniques. For example, when a viewer presses “Guide” on the remote control device 18, the Smart IPG 52 changes the regular program view on the television screen to a program guide view. Other ways to initiate the program guide 100 may be to press another button, such as “Smart IPG” (not shown) on the remote control device 18. Also, a “Guide” button or “Smart IPG” button may be located on the set-top box 16 or on the television 20 itself. In some embodiments, the program guide 100 may be called up by the viewer in response to selections that a viewer makes in a “Settings” menu, which may also include other options such as “Enable SAP”, closed captioning, etc.

Referring again to FIG. 4, the program guide 100 includes a number of additional selections. In response to the viewer pressing the A button 82 on the remote control device 18, for example, the program guide 100 can be configured according to the users inputs to display the program titles that are available on another date. In response to the viewer pressing the B button 84 on the remote control device 18, the program guide 100 is capable of presenting a “Browse by . . . ” menu (not shown) allowing a viewer to select how the program titles are arranged. For example, the program guide 100 enables the viewer to select Browse by Channel, Browse by Date, Browse by Theme, etc. In addition, the program guide 100 may include a “Browse by Most Watched” option, allowing the viewer to select a program guide having the Smart IPG section 106. In response to the viewer selecting the C button 86, the program guide 100 is capable of returning to a previous menu or screen or returning to the regular television program.

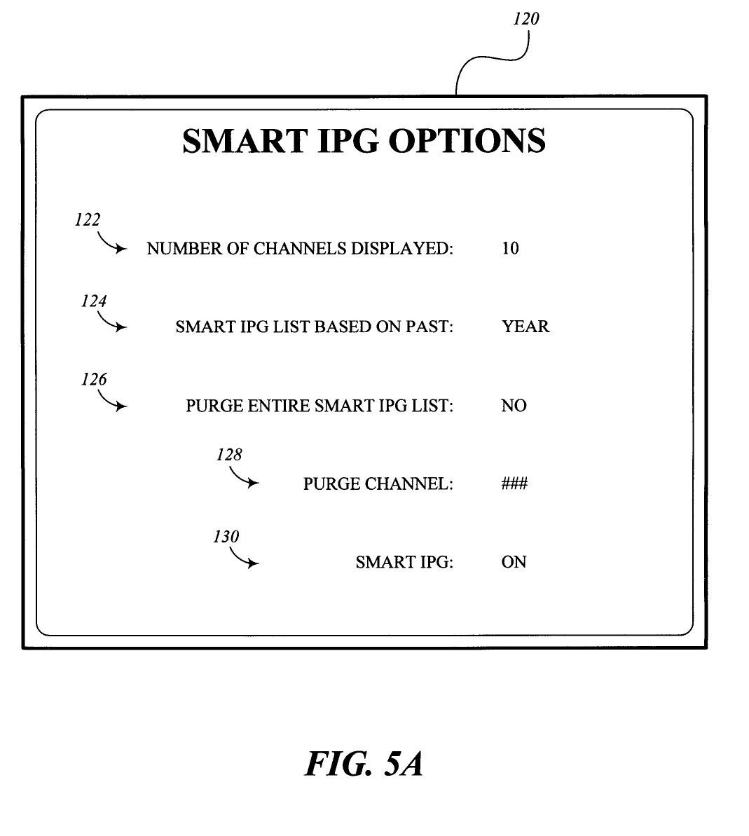

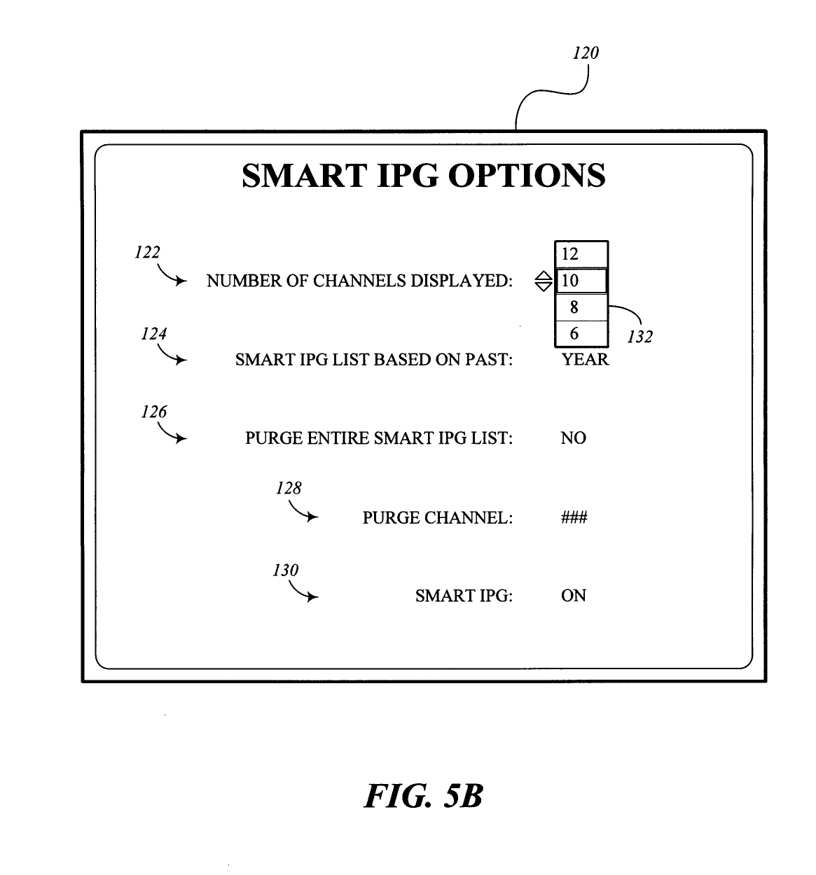

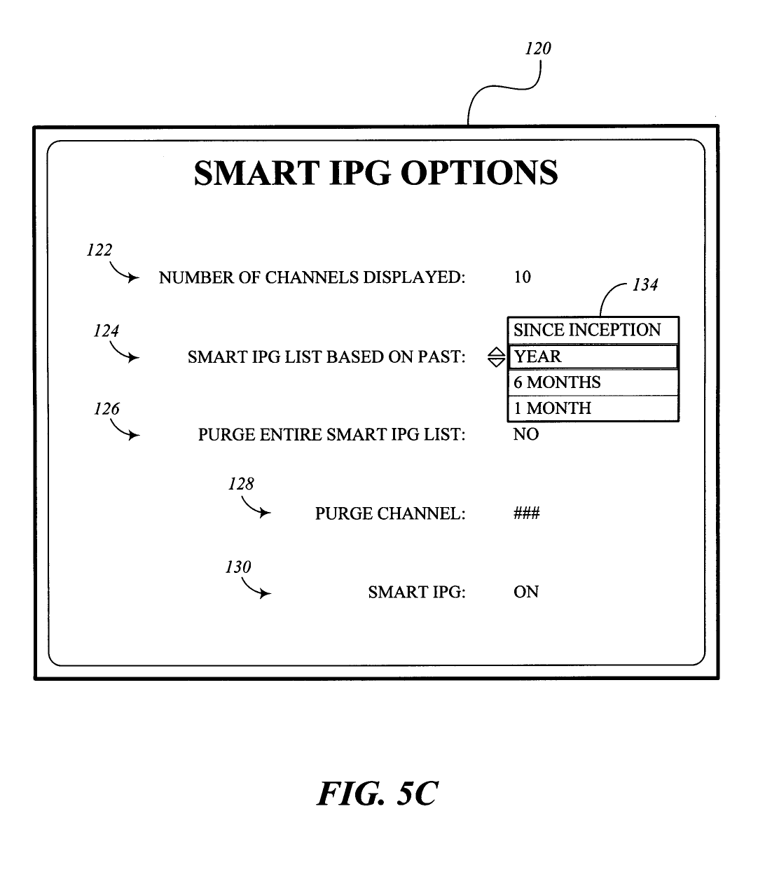

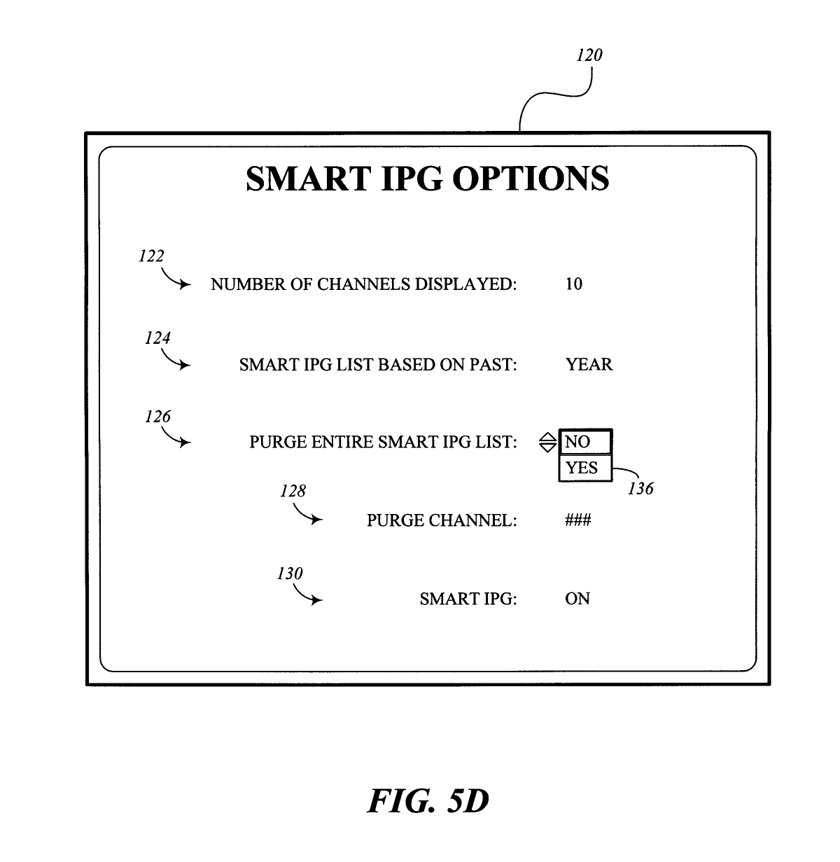

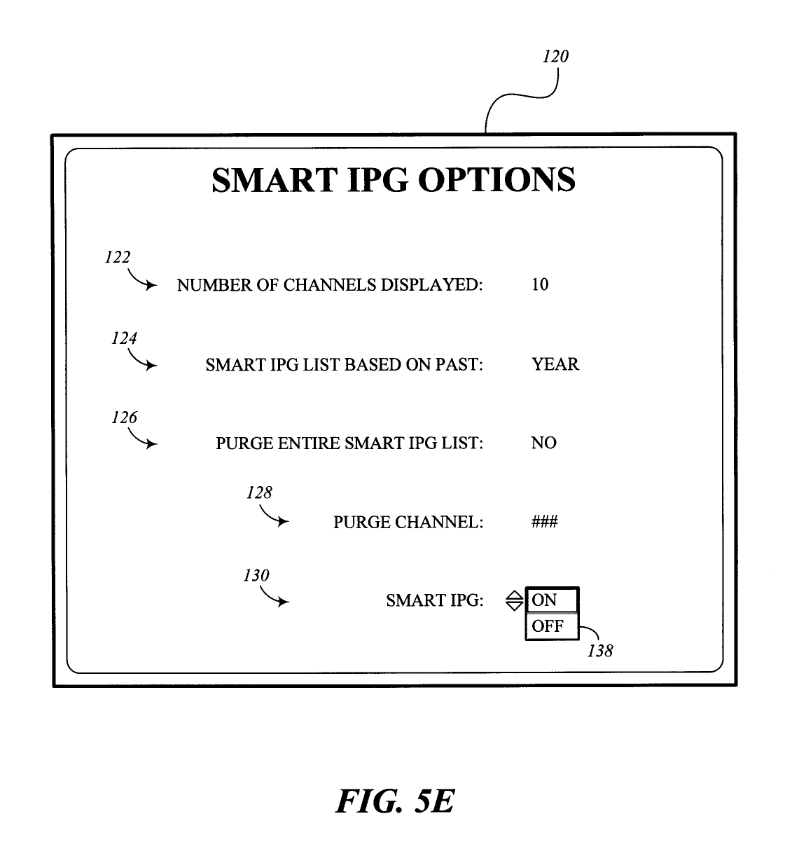

In the embodiment of FIG. 4, the program guide 100 also includes a “Smart IPG Options” selection. In response to a viewer pressing the D button 88 on the remote control device 18, the program guide changes to show one or more options to choose viewer preferences with respect to how the Smart IPG section 106 is displayed. FIG. 5A, for instance, illustrates one example of a possible screen view to be displayed for receiving viewer selections of various options. As mentioned above, other ways to navigate through various options may be realized using other suitable remote control devices or user input devices.

FIG. 5A is a diagram of an exemplary embodiment of a screen view 120 showing Smart IPG options. The screen view 120 in this implementation is configured to enable a user to select certain parameters to define how the Smart IPG section 106 is displayed in the program guide 100. Although five option categories are shown in this embodiment, it should be noted that the screen view 120 may be configured with any number of option categories according to the particular design. The different option categories can be reached, for example, by using the up arrow button 70 or down arrow button 72 on the remote control device 18. When a viewer moves to a category to be adjusted, which may be indicated by certain highlighting features, the viewer may press the select button 78 on the remote control device 18. When a category is selected, available settings for that particular category are presented for selection, as described and illustrated with respect to FIGS. SB-5E.

The screen view 120 includes a first option 122 to select the number of channels to be displayed in the Smart IPG section 106. The screen view 120 also includes a second option 124 to set the preceding time interval during which the tuned-to counts are considered. The screen view 120 also includes a third option 126 allowing a user to purge the entire list of channels in the Smart IPG. If this latter option is selected, the tuned-to counts for all the channels are reset to zero and the Smart IPG reverts to the factory default. The screen view 120 also includes a fourth option 128, allowing the viewer to purge a channel from the list of Smart IPG channels. This may be useful, for example, if a visitor, having different viewing habits, significantly influences the counts. Other temporary changes in viewing behavior may also alter the counts and change the rankings in a manner that may be undesirable to the viewer. The screen view 120 also includes a fifth option 130 to enable or disable the Smart IPG feature. If the user does not wish to view a program guide having the Smart IPG section 106, the Smart IPG can be turned off or temporarily disabled.

FIG. 5B illustrates an embodiment of the screen view 120 of FIG. SA when the first option 122 is selected. When selected, a window 132 showing available settings for the first option is shown. If not all settings can be seen, then scrolling through the settings of the window 132 allows the user to see any of the available settings. The screen view 120 is configured to allow the first option 122 to be adjusted by enabling a user to choose a desired setting by pressing the up arrow button 70 or down arrow button 72, for instance, on the remote control device 18. In some embodiments, the settings for the first option 122 may be configured in other ways to allow a user to input a desired number of channels to be displayed in the Smart IPG section 106. The menu of settings may contain selectable choices ranging from about two channels to about twelve channels, for example, but not necessarily limited to such a range. When the user scrolls to the desired number, the user can press the select button 78 to select the particular setting.

FIG. 5C illustrates an embodiment of the screen view 120 of FIG. SA when the second option 124 is selected. When the second option 124 is selected, a window 134 is shown in the screen view 120 to show available settings. With respect to the second option, the Smart IPG 52 is configured to consider the number of times that each channel is tuned-to during a selectable past time period. Also, the Smart IPG 52 may disregard, or even drop or purge, records that are older than the selected time period. In this non-limiting example, the second option 124 is set for YEAR to cause the Smart IPG to consider the viewing history over the preceding one year. Records having an age of more than the selected time, e.g. one year, are dropped and records having an age of less than the selected time are analyzed to determine the channels most often tuned to.

Rather than showing window 134, the available settings for the second option 124 may be configured in any other suitable manner to allow a user to enter selections within certain guidelines. As an example, the time intervals available for selection may include one week, two weeks, one month, six months, one year, and since inception. However, the selections are not necessarily limited to such a range and may instead include any suitable range or choices according to the particular design. The option “since inception” may be available to enable a user to select a time interval representing a running total of the entire history of the viewers' watching behavior.

FIG. 5D illustrates an embodiment of the screen view 120 when the third option 126 is selected. When selected, window 136 can be displayed enabling the user to select YES or NO. If YES is selected, the Smart IPG 52 purges the counts for all the channels. From the time of purging, the Smart IPG 52 can begin recording the counts again to build up a new viewing-behavior count. Toggling between NO and YES in other embodiments may be performed by other suitable methods to restart the channel counts.

If a particular channel is to be purged, the viewer can select the fourth option 128. When selected, the viewer is allowed to enter a channel number using the number pad on the remote control device 18, for example, to purge a particular channel from the list of Smart IPG channels. This may be useful, for example, if a visitor, having different viewing habits, significantly influences the counts. Other temporary changes in viewing behavior may also alter the counts and change the rankings in a manner that may be undesirable to the viewer. If this is the case, the viewer can purge or remove one or more of the channels from the list. To purge a channel, the Smart IPG 52 may reset the tuned-to count for the selected channel to zero.

FIG. 5E illustrates an embodiment of the screen view 120 of FIG. SA when the fifth option 130 has been selected. When selected, another window 138 may be displayed showing available selections. In this case, the viewer can choose between ON or OFF to enable or disable the Smart IPG 52. If disabled, the user can go back at a later time and enable the feature. Again, the button on the remote control device 18 may be used to make selections.

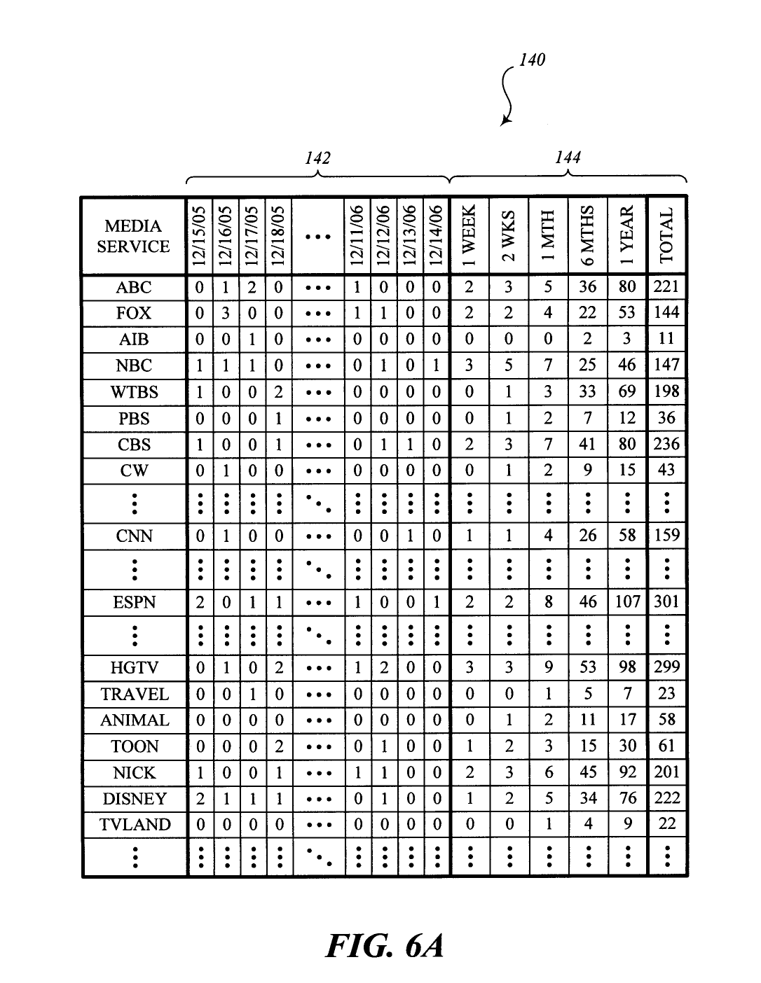

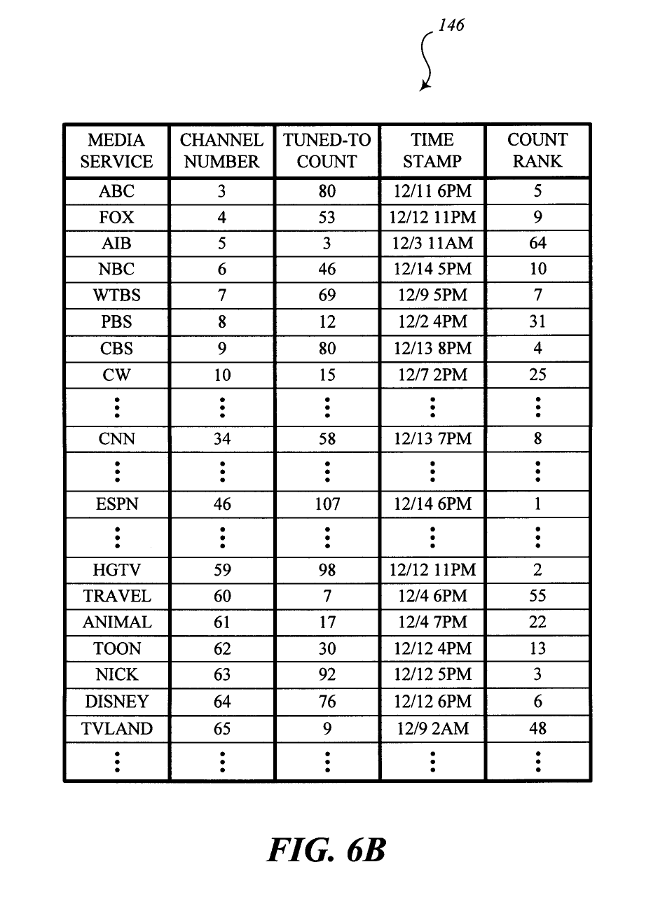

FIG. 6A is a diagram illustrating an embodiment of a table 140 including exemplary information collected with respect to the operations of the Smart IPG 52 (FIG. 2). The table 140 includes a list of offered media services, a daily count tally 142, and time interval tallies 144. The daily count tally 142 includes the tuned-to counts for each media service for each day over a specific period of time. From these counts, the time interval tallies 144 can be calculated. For the one-week tally, for example, the counts from the previous seven days are added.

Each column of the time interval tallies 144 can be calculated each day at a time when the set-top box 16 is less busy. The TOTAL column is simply a running total of all counts for the respective channel since inception. In this exemplary table 140, the records older than one year may be deleted, shifted out, or overwritten with newer information. When the entire Smart IPG list is purged, all cells in the table 140 are reset to zero. When a single channel is purged, the cells in the row corresponding to the respective channel are reset to zero.

FIG. 6B is a diagram of an embodiment of a table 146 including exemplary information stored with respect to the operations of the Smart IPG 52 and including information derived from table 140 of FIG. 6A. Tables 140 and 146, in other embodiments, may contain other suitable configurations or structures for storing data. The table 146 includes the list of offered media services and the currently applicable channel number for the respective service. As mentioned above, the channel numbers may change based on a reconfiguration of the channel lineup by a service operator. Therefore, particular tuned-to counts may be attributed to the service instead of the channel number and the channel numbers may be applied to the respective service based on the particular channel map in effect.

The table 146 also includes tuned-to counts representing the number of times during a certain time period that the viewers tuned to the particular television, game, music, or DVR services. The time period is selectable based on user input, but may default to the one-year time frame. In this exemplary table 146, the tuned-to count is taken from the ONE-YEAR column of the time interval tallies 144 of table 140 (FIG. 6A). It should be noted from the time interval tallies 144 of table 140 that the channels may have a different ranking based on which particular past time period has been selected.

Also, a time stamp is recorded to represent the most recent time that the tuner system 24 was tuned to the particular service. The time stamp may be used as a tiebreaker if two or more services have the same number of tuned-to counts. In the exemplary numbers in table 140, for example, the services ABC and CBS have both been tuned to 80 times. However, since the time stamp for CBS is more recent, it receives a higher ranking, which is presented in the “count rank” column of the table 146. Services with a “higher ranking” are given a lower number in the “count rank” column. In some embodiments, channels that have the same tuned-to counts may simply be ranked based on which one has the lower channel number, and, in this case, the time stamp can simply be disregarded.

The Smart IPG 52 (FIG. 2) determines the ranking, shown in the Count Rank column of table 146 based on the tuned-to counts for each channel. In this example, ESPN has the higher number of tuned-to counts over the past year, i.e. 107, and is therefore ranked as 1 in the count ranking. The Smart IPG 52 determines the television service HGTV, for example, to be ranked second for having the second highest number of tuned-to counts, and so on. Based on the count rank, the program guide 100 of FIG. 4 displays the Smart IPG section 106 with the highest ranking service, i.e. ESPN, in the top position, HGTV in the next position, and so on, as shown in FIG. 4. Also, the program guide 100 may be configured to highlight the highest-ranking channel for easy access to this most often tuned-to channel.

When the counts recorded in the tuned-to count column are purged, as a result of the purge option 128 (FIG. 5) or when a new set-top box 16 is first installed in a residence, the counts for all channels are set to zero. In this case, the Smart IPG 52 does not include any useful information to set a count ranking in order to list the services accordingly. Therefore, the Smart IPG may simply display the first number of channels in the channel lineup or list the channels according to a preset arrangement or default.

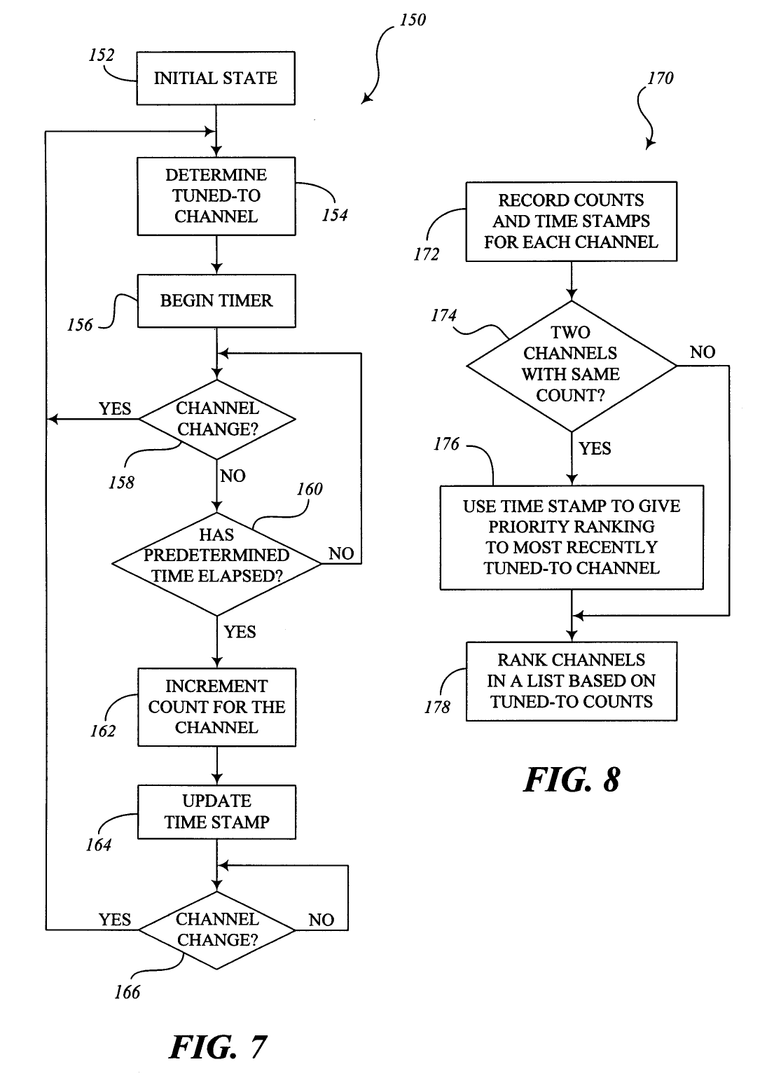

The information in the table 146 may be stored in flash memory 38 (FIG. 2). Thus, if the set-top box 16 is turned off or if there is a power outage, then the information is not lost. When the set-top box 16 is powered up again, the Smart IPG 52 performs certain functions, such as those described, for example, with respect to FIGS. 7 and 8, which are related to managing which channels can be displayed in the Smart IPG section 106 of the program guide 100.

FIG. 7 is a flow chart of an embodiment of a process 150 that may be performed by the Smart IPG 52 or other suitable program guide application. In this process of FIG. 7, a counting routine is performed for counting the number of times that each channel is tuned to. This routine begins in block 152 when the set-top box is already fully booted and when it is first powered up. If the cable provider configures the set-top box to power up to a default channel, e.g. channel 1, then the process 150 remains in the initial state (block 152) until the viewer changes to a new channel. On the other hand, if the cable provider configured the set-top box to power up to the last channel viewed, then the process 150 proceeds to block 154.

In block 154, it is determined which channel the tuner is currently tuned to. In block 156, a timer is started. In decision block 158, it is determined whether or not the channel is changed. If not, block 158 proceeds to block 160. If the channel is changed, the process 150 goes to block 154 to determine the new channel and to reset the timer in block 156. In decision block 160, it is determined whether or not a predetermined amount of time has elapsed. The predetermined time period is used to avoid counting tuned-to counts when a viewer only dwells on a channel for a short amount of time, such as during channel surfing. If the predetermined time has not elapsed, then the flow loops back to block 158 for detecting if the channel is changed. If it is determined in decision block 160 that the channel has not been changed for at least the predetermined time period, then the process 150 flows to block 162.

In block 162, a count for the currently tuned-to channel is incremented. In block 164, a time stamp is applied to the channel. If the channel already has a time stamp, from a previous viewing time, the time stamp is updated with the most recent viewing. The time stamp can replace any older time stamps for that particular channel to keep track of the latest viewing of the channel. In decision block 166, it is determined whether or not the channel is changed. When the channel is changed, the process flows to block 154, to determine a new channel and restart a new timing period for the next channel. The process 150 is repeated indefinitely at block 166 when the channel is not changed or until the set-top box 16 is turned off or rebooted.

FIG. 8 is a flow chart of an embodiment of a second process 170 that may be performed by the Smart IPG 52. In the second process 170, a routine is performed to rank the channels based on a count of the number of times that the channels are tuned to. The counts may be determined, for example, from process 150 of FIG. 7 or from other counter routines for counting the number of times that a tuning system tunes to the channels.

In block 172, the tuned-to counts and time stamps are recorded for each channel. The counts may be automatically recorded in a look-up table, such as the table 146 of FIG. 6B, for example. Block 172 includes checking whether the count and time stamp information is older than a selected preceding time interval during which the counts are to be considered. The records that are too old can be discarded in order that only the most recent information is used in the ranking calculations. In decision block 174, it is determined whether two channels have the same counts. If not, the process goes to block 178. If two channels do have the same counts, then the process goes to block 176, where the time stamps of the two channels are compared to determine the channel with the most recent time stamp. The channel most recently watched, based on the time stamp, is flagged to be given priority in the count list.

In block 178, the channels are ranked in a list based on the tuned-to counts. Also, if necessary, the ranking may be influenced by the time stamp if two channels have the same count, as mentioned above. At this point, the channels are ranked based on count and can be presented in this particular order on a program guide, such as the program guide 100 of FIG. 4 or other display view showing television programs having channels listed in a certain order or ranking. When a viewer initiates the program guide, the list can be accessed and inserted into the program guide with each channel's related information.

The flow charts of FIGS. 7 and 8 show the architecture, functionality, and operation of possible implementations of the Smart IPG. In this regard, each block may represent a module, segment, or portion of code in software and may comprise one or more executable instructions for implementing the specified logical function(s). It should also be noted that in some alternative implementations, the functions noted in the blocks may occur out of the order shown, executed substantially concurrently with other blocks, or executed in the reverse order as shown, depending upon the functionality involved, as would be understood by those reasonably skilled in the art.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

I claim:

1. An application stored in memory and configured to control an interactive program guide (IPG) to be displayed on a display screen, the application comprising:
logic configured to maintain a data structure having a first category corresponding to a plurality of media services and a second category corresponding to a first value representing the number of times that a tuner system tunes to each one of the media services;
logic configured to detect when the tuner system tunes to a particular media service channel; and
logic configured to increment the first value related to the particular media service channel in response to detecting the tuner system tuning to the particular media service channel.

2. The application of claim 1, wherein the logic configured to detect when the tuner system tunes to a particular media service channel is further configured to detect when the tuner system remains tuned to the particular media service channel for a predetermined length of time.

3. The application of claim 2, wherein the logic configured to increment is further configured to increment the first value when it is detected that the tuner system remains tuned to the particular media service channel for the predetermined length of time.

4. The application of claim 1, further comprising logic configured to rank the channels in an order based on the first value.

5. The application of claim 1, wherein the data structure includes a third category corresponding to a second value representing the most recent time that the tuner system was tuned to each one of the media services.

6. The application of claim 5, further comprising logic configured to rank the channels in an order based on the first value, wherein, when the first value of two or more channels is the same, the logic configured to rank the channels is configured to use the second value to rank the two or more channels based the most recent time.

7. A set-top box comprising:
a processor adapted to control operations of the set-top box; and
a memory device in communication with the processor, the memory device adapted to store a program guide application executable by the processor;
wherein the program guide application is configured to provide a program guide having a first section and a second section;
wherein the first section includes a first set of media services, each of the first set of media services having a corresponding channel number and corresponding accessibility time period, the first set of media services listed in the first section in an order based on a user-selected sorting technique; and
wherein the second section includes a second set of media services, each of the second set of media services having a corresponding channel number and corresponding accessibility time period, the second set of media services listed in the second section in an order based on a count of the number of times that each respective media service is tuned to.

8. The set-top box of claim 7, wherein the program guide application is further configured to provide an options screen enabling a user to alter parameters related to the second section.

9. The set-top box of claim 8, wherein the program guide application is responsive to user inputs from a remote control device.

10. The set-top box of claim 8, wherein the options screen enables the user to select the number of channels to be displayed in the second section.

11. The set-top box of claim 8, wherein the options screen allows the user to select a time period over which the counts for the media services are considered.

12. The set-top box of claim 8, wherein the options screen allows the user to purge one or more channels from the second section.

13. The set-top box of claim 7, wherein the second section is positioned between two media services listed consecutively according to the user-selected sorting technique.

14. The set-top box of claim 13, wherein the program guide application allows the user to scroll through the media services in the first section and second section.

15. The set-top box of claim 7, wherein the program guide application is configured to change a television program view to a program guide view in response to an input from a user.

16. The set-top box of claim 15, wherein the program guide view initially consists of a portion of the second set of media services in the second section.

17. The set-top box of claim 7, wherein the set-top box is incorporated within a television set.

18. The set-top box of claim 7, wherein the user-selected sorting technique is selected from a list consisting of a numerical order based on channel number, an order based on theme, and an alphabetical order based on title.

19. A method comprising the steps of:
displaying, in a program guide, a list of media services and the corresponding channel number of each media service;
listing the media services in an order based on the number of times that a tuner tunes to each media service; and
displaying media titles corresponding to at least one time period when the media titles are available on the respective media services.

20. The method of claim 19, wherein the step of listing the media services comprises listing the media services in an order based on the number of times that the tuner tunes to each media service during a preceding time period.

21. The method of claim 19, further comprising the steps of:
determining whether the tuner tunes to two or more media services the same number of times; and
when it is determined that the tuner tunes to two or more media services the same number of times, listing the media services tuned-to the same number of times based on the media service that the tuner tuned to most recently.
